(19) United States
(12) Patent Application Publication
(10) Pub. No.: US 2016/0071394 A1
(43) Pub. Date: Mar. 10, 2016

(54) ELECTRONIC DEVICE AND METHOD FOR ACTIVATING DRIVING MODE OF THE ELECTRONIC DEVICE

(71) Applicant: Chiun Mai Communication Systems, Inc., New Taipei (TW)

(72) Inventor: CHENG-KUO YANG, New Taipei (TW)

(21) Appl. No.: 14/511,009

(22) Filed: Oct. 9, 2014

(30) Foreign Application Priority Data
Sep. 4, 2014 (CN) 201410449684.3

(51) Int. Cl. G08B 21/18; H04W 4/04

(52) U.S. Cl. CPC G08B 21/18; H04W 4/046

(57) ABSTRACT

Method of activating a driving mode of an electronic device includes obtaining a movement speed of the electronic device. The driving mode is activated when the movement speed is greater than a predetermined value, and a detection device that is connected to the electronic device, senses motion that is indicative of user movement.

### CROSS-REFERENCE TO RELATED APPLICATIONS

This application claims priority to Chinese Patent Application No. 201410449684.3 filed on Sep. 4, 2014, the contents of which are incorporated by reference herein.

### FIELD

Embodiments of the present disclosure relate to communication management, and particularly to an electronic device and method for activating a driving mode of the electronic device.

### BACKGROUND

A driving mode in an electronic device (e.g., a mobile phone) is a feature which allows incoming calls and other new notifications (e.g., messages or emails) in the electronic device to be automatically read aloud. With the help of this feature, the user may manually switch the electronic device into the driving mode when driving.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagrammatic view of one embodiment of an electronic device including an activating system.

FIG. 2 illustrates a flowchart of one embodiment of a method for activating a driving mode of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives.

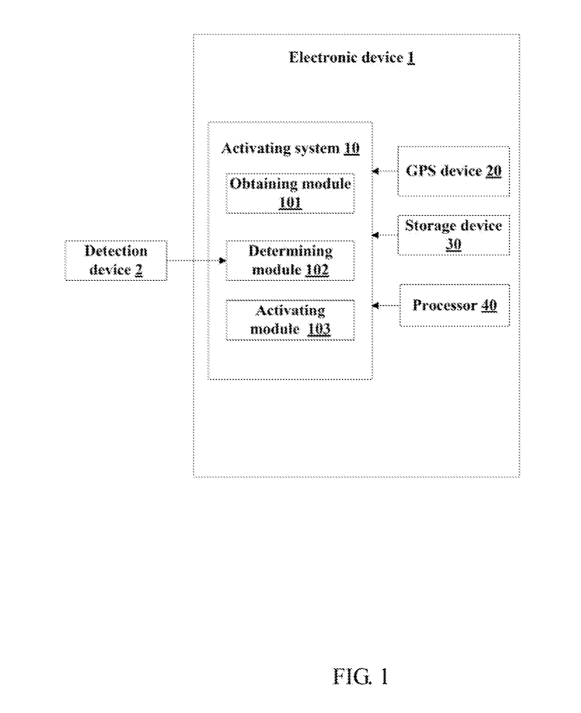

FIG. 1 illustrates a diagrammatic view of one embodiment of an electronic device. Depending on the embodiment, an electronic device 1 includes an activating system 10, a global position system (GPS) device 20, a storage device 30, and at least one processor 40. The electronic device 1 can be a smart phone, a personal digital assistant (PDA), a tablet computer, or any other suitable electronic device. FIG. 1 illustrates only one example of the electronic device 1 that can include more or fewer components than illustrated, or have a different configuration of the various components in other embodiments.

In the embodiment, the GPS device 20 obtains a movement speed of the electronic device 1. The activating system 10 automatically activates a driving mode of the electronic device 1 when the movement speed is greater than a predetermined value and a user of the electronic device 1 is determined to be driving. In the embodiment, when the electronic device 1 enters the driving mode, the activating system 10 informs the user of an incoming call or a new notification (e.g., a new message or an email) by outputting an audio prompt.

In the embodiment, the activating system 10 determines whether the user is driving, using a detection device 2 that is connected to the electronic device 1. In at least one embodiment, the detection device 2 is a wearable device which can be worn on a hand of the user. The detection device 2 includes a gravity sensor and/or a gyro sensor (not indicated in FIG. 1), which are used to detect whether the hand of the user is moving in a circular direction. In at least one embodiment, when the detection device 2 detects the hand of the user is moving in the circle, the activating system 10 determines that the user is driving.

It is noted that when the user is driving, the user needs to control the direction of a vehicle by rotating a steering wheel of the vehicle using the hand. As the steering wheel is circular, when the user controls direction of the vehicle, the hand is moving in a circular direction. That is, when the detection device 2 is worn on the hand of the user, the activating system 10 can use the detection device 2 to determine whether the user is driving.

The storage device 30 can be an internal storage device, such as a flash memory, a random access memory (RAM) for temporary storage of information, and/or a read-only memory (ROM) for permanent storage of information. The storage device 30 can also be an external storage device, such as an external hard disk, a storage card, or a data storage medium. The at least one processor 40 can be a central processing unit (CPU), a microprocessor, or other data processor chip that performs functions of the electronic device 1.

In at least one embodiment, the activating system 10 can include an obtaining module 101, a determining module 102, and an activating module 103. The function modules 101, 102, and 103 can include computerized codes in the form of one or more programs, which are stored in the storage device 30, and are executed by the at least one processor 40 to provide functions of the present disclosure. Details will be given in the following paragraphs.

The obtaining module 101 obtains the movement speed of the electronic device 1. In the embodiment, the obtaining module 101 obtains the movement speed from the GPS device 20.

The determining module 102 determines whether the movement speed is greater than the predetermined value. In at least one embodiment, the determining module 102 provides an interface for the user to preset the predetermined value. For example, the user presets the predetermined value to be 10 kilometers per hour on the interface.

The determining module 102 further determines whether the user of the electronic device 1 is driving using the detection device 2, when the movement speed is greater than the predetermined value.

As mentioned above, the detection device 2 is a wearable device which can be worn on the hand of the user. The detection device 2 includes the gravity sensor and/or the gyro sensor which are used to detect whether the hand of the user is moving in a circular direction. In one embodiment, when the detection device 2 detects the hand of the user is moving in a circular direction, the determining module 102 determines that the user is driving.

The activating module 103 activates the driving mode of the electronic device 1 when the user is determined to be driving. In the embodiment, when the electronic device 1 enters the driving mode, the activating module 103 informs the user the incoming call or the new notification (e.g., the new message or the new email) by outputting the audio prompt.

For example, the activating module 103 informs the user of the incoming call by reading out a caller's information (e.g., a name of the caller and/or a phone number of the incoming call) when receiving the incoming call. For another example, the activating module 103 informs the user of the new message by reading out sender information (e.g., a name or a phone number of the sender) and the contents of the new message when the new message arrives.

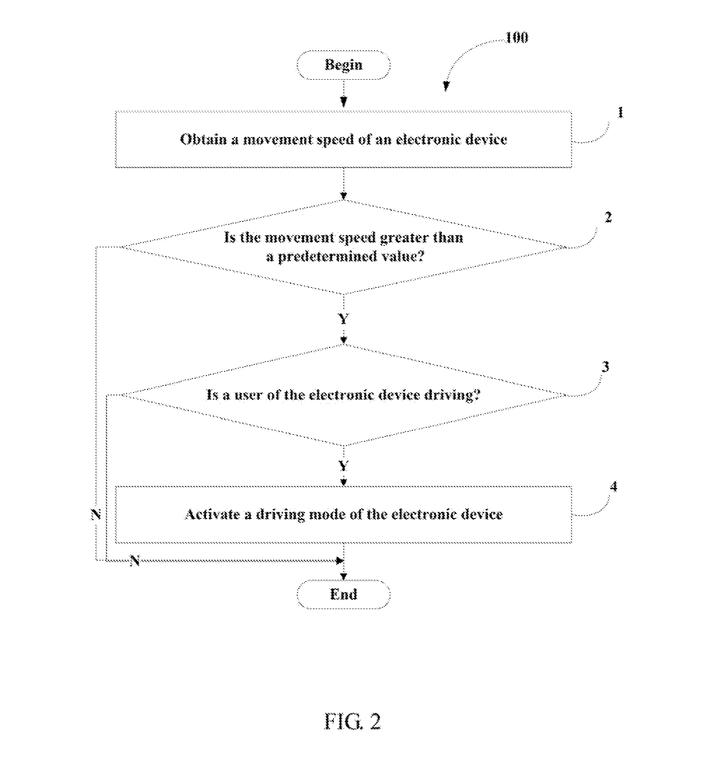

FIG. 2 illustrates a flowchart in accordance with an example embodiment. The method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 2 represents one or more processes, methods or subroutines, carried out in the exemplary method 100. Additionally, the illustrated order of blocks is by example only and the order of the blocks can be changed according to the present disclosure. The exemplary method 100 can begin at block 1. Depending on the embodiment, additional steps can be added, others removed, and the ordering of the steps can be changed.

In block 1, an obtaining module obtains a movement speed of an electronic device. In the embodiment, the obtaining module obtains the movement speed from a global positioning system (GPS) device of the electronic device.

In block 2, a determining module determines whether the movement speed is greater than a predetermined value. If the movement speed is greater than the predetermined value, the process goes to block 3. If the movement speed is not greater than the predetermined value, the process ends.

In at least one embodiment, the determining module provides a user of the electronic device an interface to preset the predetermined value. For example, the user presets the predetermined value to be 10 kilometers per hour on the interface.

In block 3, the determining module further determines whether the user is driving using a detection device that is connected to the electronic device. If the user is driving, the process goes to block 4. If the user is not driving, the process ends.

In the embodiment, the detection device is a wearable device which can be worn on a hand. The detection device includes a gravity sensor and/or a gyro sensor which are used to detect whether the hand of the user is moving in a circular direction. In one embodiment, when the detection device detects the hand of the user is moving in a circular direction, the determining module determines that the user is driving.

In block 4, an activating module activates a driving mode of the electronic device when the user is determined to be driving. In the embodiment, when the electronic device enters the driving mode, the activating module informs the user of an incoming call or a new notification (e.g., a new message or a new email) with an audio prompt.

For example, the activating module informs the user of the incoming call by reading out caller information (e.g., a name of the caller and/or a phone number of the incoming call). For another example, the activating module informs the user of the arrival of the new message by reading out sender information (e.g., a name or a phone number of the sender) and contents of the new message.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for activating a driving mode of an electronic device being executed by a processor of the electronic device, the method comprising:
obtaining a movement speed of the electronic device;
determining, when the movement speed is greater than a predetermined value, whether a detection device that is connected to the electronic device senses motion that is indicative of user movement; and
activating the driving mode of the electronic device when the detection device senses motion that is indicative of user movement.

2. The method according to claim 1, wherein the movement speed is obtained from a global positioning system (GPS) device of the electronic device.

3. The method according to claim 1, wherein the detection device is a wearable device that is worn on a hand of the user, and the detection device detects whether the hand of the user is moving in a circular direction using a gravity sensor and/or a gyro sensor of the detection device.

4. The method according to claim 3, wherein the user is determined to be driving when the hand of the user is determined to be moving in the circular direction.

5. The method according to claim 1, further comprising:
when the electronic device enters the driving mode, informing the user of an incoming call or a new notification by outputting an audio prompt.

6. An electronic device comprising:
at least one processor; and
a storage device that stores one or more programs, when executed by the at least one processor, cause the at least one processor to:
obtain a movement speed of the electronic device;
determine, when the movement speed is greater than a predetermined value, whether a detection device that is connected to the electronic device senses motion that is indicative of user movement; and
activate the driving mode of the electronic device when the detection device senses motion that is indicative of user movement.

7. The electronic device according to claim 6, wherein the movement speed is obtained from a global positioning system (GPS) device of the electronic device.

8. The electronic device according to claim 6, wherein the detection device is a wearable device that is worn on a hand of the user, and the detection device detects whether the hand of the user is moving in a circular direction using a gravity sensor and/or a gyro sensor of the detection device.

9. The electronic device according to claim 8, wherein the user is determined to be driving when the hand of the user is determined to be moving in the circular direction.

10. The electronic device according to claim 6, further comprising:
when the electronic device enters the driving mode, informing the user of an incoming call or a new notification by outputting an audio prompt.

11. A non-transitory storage medium having stored thereon instructions, when executed by a processor of an electronic device, cause the processor to perform a method for activating a driving mode of the electronic device, wherein the method comprises:
obtaining a movement speed of the electronic device;
determining, when the movement speed is greater than a predetermined value, whether a detection device that is connected to the electronic device senses motion that is indicative of user movement; and
activating the driving mode of the electronic device when the detection device senses motion that is indicative of user movement.

12. The non-transitory storage medium according to claim 11, wherein the movement speed is obtained from a global positioning system (GPS) device of the electronic device.

13. The non-transitory storage medium according to claim 11, wherein the detection device is a wearable device that is worn on a hand of the user, and the detection device detects whether the hand of the user is moving in a circular direction using a gravity sensor and/or a gyro sensor of the detection device.

14. The non-transitory storage medium according to claim 13, wherein the user is determined to be driving when the hand of the user is determined to be moving in the circular direction.

15. The non-transitory storage medium according to claim 11, further comprising:
when the electronic device enters the driving mode, informing the user of an incoming call or a new notification by outputting an audio prompt.
